(19) United States
(12) Patent Application Publication
(10) Pub. No.: US 2024/0095502 A1
(43) Pub. Date: Mar. 21, 2024

(54) ARTIFICIAL NEURON NETWORK HAVING AT LEAST ONE UNIT CELL QUANTIFIED IN BINARY

(71) Applicant: STMicroelectronics (Rousset) SAS, Rousset (FR)

(72) Inventors: Pierre Demaj, Nice (FR); Laurent Folliot, Gourdon (FR)

(21) Appl. No.: 18/470,281

(22) Filed: Sep. 19, 2023

(30) Foreign Application Priority Data
Sep. 21, 2022 (FR) 2209551

(51) Int. Cl. G06N 3/0464

(52) U.S. Cl. CPC G06N 3/0464

(57) ABSTRACT

An artificial neural network includes a unit cell. The unit cell includes a first binary two-dimensional convolution layer configured to receive an input tensor and to generate a first tensor. A first batch normalization layer is configured to receive the first tensor and to generate a second tensor. A concatenation layer is configured to generate a third tensor by concatenating the input tensor and the second tensor. A second binary two-dimensional convolution layer is configured to receive the third tensor and to generate a fourth tensor. A second batch normalization layer is configured to generate an output tensor based on the fourth tensor.

### CROSS-REFERENCE TO RELATED APPLICATIONS

This application claims priority to French Application Number 2209551 filed on Sep. 21, 2022, which application is hereby incorporated herein by reference.

### TECHNICAL FIELD

Embodiments and implementations of the present disclosure generally relate to artificial neural networks, and particular embodiments relate to artificial neuron networks having at least one unit cell quantified in binary.

### BACKGROUND

The artificial neural networks generally comprise a succession of layers of neurons. Each layer takes as input data to which weights are applied and outputs data, in particular a data tensor, after processing by functions for activating the neurons of said layer. This output data is transmitted to the next layer in the neural network.

The weights are data, more particularly parameters, of configurable neurons to obtain good data at the output of the layers.

The weights are adjusted during a generally supervised learning phase, in particular by executing the neural network with, as input data, already classified data from a reference database.

The neural networks can be quantized. In particular, the quantization of the neural network consists in defining a format for representing neural network data, such as the weights as well as the inputs and outputs of each layer of the neural network. The layers of a neural network can be quantized in floating point, in eight bits.

However, the floating-point or eight-bit quantized neural networks have significant memory requirements for storing the weights and data generated by the different layers of these neural networks.

Thus, some neural networks are at least partially binary quantized to accelerate their execution and reduce the memory requirements for storing the weights and data generated by the different layers of the neural networks.

A neural network can thus include at least one binary quantized layer. The weights of said at least one layer then take the value ‘0’ or ‘1’. The values generated by certain layers of the neural network (in other words, the “activations”) can also be binary, and therefore take the value ‘0’ or ‘1’. The neural network can nevertheless have certain layers, in particular an input layer and an output layer, quantized in eight bits or in floating points. The layers, called hidden layers, located between the input layer and the output layer can then be binary quantized. A binary quantized neural network for most of these layers can be obtained simply to identify (classify) an element in the physical signal.

The at least partially binary quantized neural networks are designed to be executed faster than the floating-point or eight-bit quantized neural networks, and to reduce the memory requirements relative to the latter neural networks.

Nevertheless, the design of an at least partially binary neural network is generally more complex than that of the floating-point or eight-bit quantized neural networks.

In particular, certain floating-point or eight-bit quantized neural network topologies are not always adapted for binary quantized neural networks. In particular, certain topologies used for floating-point or eight-bit quantized neural networks and applied to a binary quantized neural network may lead to a loss of information between the layers of this binary quantized neural network. This loss of information can cause a decrease in the accuracy of the binary quantized neural network. Thus, these topologies do not always allow obtaining sufficient performance in terms of accuracy for binary quantized neural networks.

For example, a known topology for floating-point or eight-bit quantized neural networks consists in carrying out a succession of a depthwise convolution layer and a pointwise convolution layer. Such a topology is not suitable for the binary quantized neural networks because of the loss of information that it can cause.

In order to compensate for losses of accuracy of a binary quantized neural network, it is common to increase the number of layers of the neural network. However, increasing the number of layers increases the memory requirements for storing the weights of these layers as well as the data generated by these layers. It is also possible to keep some floating-point or eight-bit quantized layers to maintain a sufficient accuracy of the neural network, but this also leads to an increase in the memory requirements.

### SUMMARY

In accordance with at least one embodiment, the present disclosure provides an artificial neural network that includes at least one unit cell. The at least one unit cell includes a first binary two-dimensional convolution layer configured to receive an input tensor and to generate a first tensor. A first batch normalization layer is configured to receive the first tensor and to generate a second tensor. A concatenation layer is configured to generate a third tensor by concatenating the input tensor and the second tensor. A second binary two-dimensional convolution layer is configured to receive the third tensor and to generate a fourth tensor. A second batch normalization layer is configured to generate an output tensor based on the fourth tensor.

In at least one embodiment, a computer program product is provided that includes instructions which, when executed by processing circuitry, cause the processing circuitry to implement an artificial neural network. The artificial neural network includes at least one unit cell. The at least one unit cell includes a first binary two-dimensional convolution layer configured to a first tensor based on an input tensor. A first batch normalization layer is configured to generate a second tensor based on the first tensor. A concatenation layer is configured to generate a third tensor based on the input tensor and the second tensor. A second binary two-dimensional convolution layer is configured to generate a fourth tensor based on the third tensor. A second batch normalization layer is configured to generate an output tensor based on the fourth tensor.

In at least one embodiment, a device is provided that includes a computer-readable memory configured to store instructions for implementing an artificial neural network, and processing circuitry configured to implement the artificial neural network by executing the instructions stored in the computer-readable memory. The artificial neural network includes at least one unit cell. The at least one unit cell includes a first binary two-dimensional convolution layer configured to receive an input tensor and to generate a first tensor. A first batch normalization layer is configured to receive the first tensor and to generate a second tensor. A concatenation layer is configured to generate a third tensor by concatenating the input tensor and the second tensor. A second binary two-dimensional convolution layer is configured to receive the third tensor and to generate a fourth tensor. A second batch normalization layer is configured to generate an output tensor based on the fourth tensor.

In at least one embodiment, a method is provided that includes: generating, by a first binary two-dimensional convolution layer of a unit cell of an artificial neural network, a first tensor based on an input tensor; generating, by a first batch normalization layer of the unit cell, a second tensor based on the first tensor; generating, by a concatenation layer of the unit cell, a third tensor by concatenating the input tensor and the second tensor; generating, by a second binary two-dimensional convolution layer of the unit cell, a fourth tensor based on the third tensor; and generating, by a second batch normalization layer of the unit cell, an output tensor based on the fourth tensor.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates an artificial neural network, in accordance with one or more embodiments;

FIG. 2 illustrates an artificial neural network including a pooling layer, in accordance with one or more embodiments;

FIG. 3 illustrates an artificial neural network including a plurality of successive unit cells, in accordance with one or more embodiments;

FIG. 4 illustrates a device for implementing an artificial neural network, in accordance with one or more embodiments; and

FIG. 5 illustrates a method for processing a tensor, in accordance with one or more embodiments.

### DETAILED DESCRIPTION OF ILLUSTRATIVE EMBODIMENTS

In various embodiments, the present disclosure provides solutions which facilitate or allow obtaining at least partially binary quantized neural networks and having good performance in terms of accuracy, execution time and memory requirements.

According to one aspect, an artificial neural network is proposed, including a unit cell comprising:
a first binary two-dimensional convolution layer configured to receive an input tensor and to generate a first tensor, then
a first batch normalization layer, then
a concatenation layer configured to generate a tensor concatenating the input tensor and a tensor generated by the first batch normalization layer, then
a second binary two-dimensional convolution layer, then
a second batch normalization layer.

The neural network therefore includes a unit cell including only binary quantized layers. In other words, the layers of the unit cell include one-bit quantized weights and the tensors taken at the input and at the output of each of these layers also have one-bit quantized values. Thus, the execution of such a neural network is faster, requires less memory resources, and consumes less energy relative to a floating-point or eight-bit quantized neural network. Furthermore, it is possible to configure such a unit cell depending on the dimensions of the desired input tensor and output tensor. Moreover, the concatenation layer allows effectively training the neural network by gradient backpropagation. In this manner, the trained neural network allows reducing the losses of accuracy relative to the floating-point or eight-bit quantized neural networks.

In an advantageous embodiment, the first binary two-dimensional convolution layer is performed depthwise on the input tensor (“depthwise convolution”).

Advantageously, the second binary two-dimensional convolution layer is performed pointwise on the tensor generated by the concatenation layer (“pointwise convolution”).

Preferably, said at least one unit cell also includes a pooling layer between the second binary two-dimensional convolution layer and the second batch normalization layer.

The pooling layer can be a maximum (“maxpool”) or minimum (“minpool”) pooling layer. In particular, the pooling layer allows combining the outputs of the convolution layer. The combination of the outputs can consist, for example, in taking the maximum (“maxPooling”) or minimum (“minpooling”) value of the outputs of the convolution layer. The pooling layer allows reducing the size of the output maps of the convolution layer, while improving the performance of the neural network.

In an advantageous embodiment, the neural network further includes at least one attribute extraction layer configured to extract attributes from an input data tensor and to generate a tensor of the extracted attributes, said at least one unit cell being configured to receive as input the tensor of the extracted attributes. The input tensor can be of any type. For example, the input tensor can be a raw signal generated by a sensor, or else a transformed signal. The attribute extraction layer can be configured to perform convolution functions, non-linear functions or matrix operations.

Advantageously, at least one classification layer configured to receive the tensor generated at the output of said at least one unit cell, to classify the data tensor received at the input of the neural network from the tensor generated at the output of said at least one unit cell, and to output the determined class from the neural network.

The classification layer can be of any type. It is configured to return a class of the tensor it receives, this class being determined from a list of possible classes.

Alternatively, the neural network further includes at least one detection layer configured to receive the tensor generated at the output of said at least one unit cell, to detect elements in the data tensor received at the input of the neural network from the tensor generated at the output of said at least one unit cell, and to output the detected elements from the neural network.

In particular, the detection layer can be configured to generate a value matrix which can be interpreted by the application. The matrix can for example correspond to a position and to dimensions of a detection frame delimiting a detected element, as well as to a probability associated with this element detection.

In an advantageous embodiment, the artificial neural network including a plurality of successive unit cells.

In particular, a neural network including a plurality of successive unit cells allows responding to more complex applications.

According to one aspect, a computer program product is proposed, comprising instructions which, when the program is executed by a computer, lead it to implement a neural network as previously described.

According to another aspect, a microcontroller is proposed, comprising a memory in which a program, as previously described, is stored.

According to another aspect, a method for processing a data tensor is proposed, including an implementation of a neural network as previously described.

FIG. 1 illustrates an artificial neural network (NN) 10 according to some embodiments. The artificial neural network 10 includes a unit cell UCEL.

The unit cell UCEL includes a first binary two-dimensional convolution layer CONV1. This first convolution layer CONV1 is configured to receive as input a tensor IT. The tensor IT can have several channels. For example, if the IT tensor is an image, the tensor IT can have one channel for the red color component, another channel for the green color component, and another channel for the blue color component.

This first convolution layer CONV1 is binary quantized. In other words, this first convolution layer CONV1 has one-bit quantized weights. Thus, each weight can take the value ‘0’ or ‘1’. This first convolution layer CONV1 is also configured to generate a one-bit quantized tensor T1.

The first convolution layer CONV1 is performed depthwise on the input tensor IT received at the input of this convolution layer. In other words, the convolution layer is configured to perform a convolution using two-dimensional kernels on the different channels of the tensor it receives as input. For example, the first convolution layer CONV1 is configured to generate a tensor T1 whose values are calculated from the formula:

Σᵢ₌₁^{N}wᵢxᵢ+b=±x₁±x₂± . . . ±x_{N}+b, where x₁ to x_{N} correspond to the data received at the input of the first convolution layer CONV1 applied to a kernel of size N of this convolution layer with weights w₁ to w_{N}, and b corresponds to a bias of the convolution layer. The data received as input are binarized thanks to the following sign function:

$$sign ( {x}_{i} ) = \{ \begin{matrix}0 & if {x}_{i} \geq 0 \\ 1 & if {x}_{i} < 0\end{matrix}$$

The unit cell UCEL also includes a first batch normalization layer BN1. This first batch normalization layer BN1 is configured to receive as input the binary tensor T1 delivered at the output of the first convolution layer. The first batch normalization layer BN1 is configured to generate from the tensor T1 that it receives as input, a centered and scaled binary tensor T2. In at least some embodiments, this batch normalization layer BN1 is merged with the first convolution layer CONV1 so as to generate a binary quantized tensor T2 as output.

The unit cell UCEL also includes a concatenation layer CONC. This concatenation layer CONC is configured to receive the input tensor IT and the tensor T2 generated by the first batch normalization layer BN1. The concatenation layer is configured to generate a tensor T3 concatenating the two tensors IT and T2 that it receives as input.

The unit cell UCEL further includes a second binary two-dimensional convolution layer CONV2. The second convolution layer CONV2 is configured to receive the tensor T3 generated by the concatenation layer CONC. This second convolution layer CONV2 is binary quantized. The second convolution layer CONV2 is performed pointwise on the tensor T3 received at the input of this convolution layer CONV2 so as to generate a tensor T4. In other words, the second convolution layer CONV2 is configured to perform a convolution using the same two-dimensional kernel of 1×1 dimensions on all the channels of the tensor T3 that it receives as input. For example, the second convolution layer CONV2 is configured to generate a tensor T4 whose values are calculated from the formula:

Σⱼ₌₁^{j=M}Σᵢ₌₁^{N}wᵢ^{j}xᵢ^{j}+b, where x₁^{j} to x_{N}^{j} correspond to the channel data j received at the input of the first convolution layer CONV2 applied to a kernel of size N equal to 1×1 of this convolution layer with weights w₁^{j} to w_{N}^{j}, M is the number of input channels, and b corresponds to a bias of the convolution layer.

The unit cell UCEL further includes a second batch normalization layer BN2. This second normalization layer BN2 is configured to receive the tensor T4 generated at the output of the second two-dimensional convolution layer. The second batch normalization layer BN2 is configured to generate, from the tensor T4 it receives as input, a cent red and scaled binary tensor OT.

Such a unit cell UCEL thus has two branches BR1, BR2. The UCEL unit cell is therefore not sequential. The branch BR1 allows spreading the information of the tensor IT received at the input of the unit cell UCEL using the concatenation layer CONC which performs the concatenation in binary to limit the impacts of required memory allocation. This information is therefore not lost afterwards. The unit cell UCEL can be trained so as to give more or less importance to the input tensor IT transmitted by the branch BR1 and the tensor T2 generated by the first convolution layer CONV1 of the branch BR2.

The unit cell UCEL therefore only includes binary quantized layers. Thus, the execution of such a neural network NN is faster, requires less memory resources, and consumes less energy relative to a floating-point or eight-bit quantized neural network. Such a unit cell UCEL also has the advantage of being able to be trained efficiently by gradient backpropagation, for example by a stochastic gradient algorithm. Indeed, the fact of using a concatenation layer CONC allows simply spreading the gradient when it is trained, so as to avoid a vanishing gradient problem. In this manner, the trained neural network NN allows reducing the losses of accuracy relative to the floating-point or eight-bit quantized neural networks NN. Furthermore, it is possible to configure such a unit cell depending on the dimensions of the desired input tensor IT and output tensor OT.

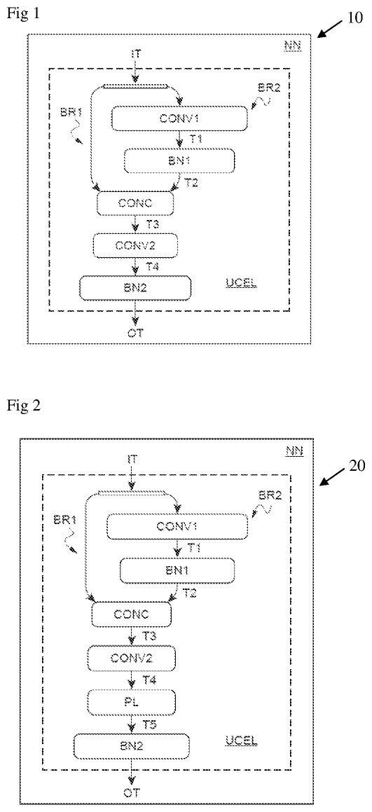

FIG. 2 illustrates an artificial neural network (NN) 20 according to some embodiments. This artificial neural network 20 has a unit cell UCEL which differs from that illustrated in FIG. 1 in that it includes a pooling layer PL between the second binary two-dimensional convolution layer CONV2 and the second batch normalization layer BN2. Thus, this pooling layer PL is configured to receive the tensor T4 generated by the second two-dimensional convolution layer CONV2. The pooling layer is configured to generate a tensor T5.

The pooling layer PL can be a maximum (“maxpool”) or minimum (“minpool”) pooling layer. In particular, the pooling layer PL allows combining the outputs of the convolution layer CONV2. The combination of the outputs can consist for example in taking the maximum (“maxPooling”) or minimum (“minpooling”) value of the outputs of the convolution layer CONV2. The pooling layer PL allows improving the performance of the neural network 20.

The batch normalization layer BN2 is then configured to take as input the tensor T5 generated by the pooling layer. The batch normalization layer BN2 is therefore configured to generate a centered and scaled binary tensor OT.

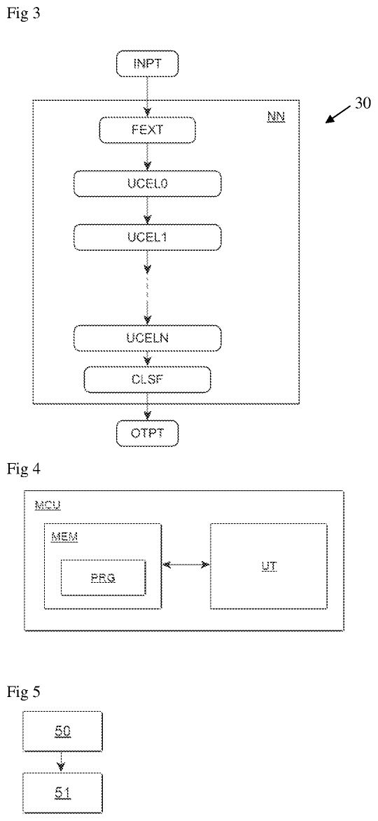

FIG. 3 illustrates an artificial neural network (NN) 30 according to a third embodiment. The neural network is configured to receive as input an input data tensor INPT. The input tensor INPT can be of any type. For example, the input tensor INPT can be a raw signal generated by a sensor, or else a transformed signal. The input tensor INPT can be an image for example.

The artificial neural network NN comprises an attribute extraction layer FEXT. The attribute extraction layer FEXT is configured to extract attributes from the input tensor. For example, when the input tensor INPT is an image, it is possible to extract information about colors and/or textures from the image.

The artificial neural network 30 also comprises a succession of unit cells UCEL0, UCEL1, . . . , UCELN such as those described in relation to FIG. 1 or FIG. 2. The number of unit cells depends on the requirements of the intended application of the neural network. For example, the number of unit cells is comprised between two and six in some embodiments; however, embodiments of the present disclosure are not limited thereto and may include any number of unit cells.

The artificial neural network 30 further comprises a classification layer CLSF. The classification layer CLSF is configured to determine a class of the input data tensor from the attributes extracted by the extraction layer. In particular, the class can be determined from a list of possible classes. The class determined by the classification layer is transmitted into an output tensor OTPT.

Alternatively, instead of the classification layer CLSF, the neural network can comprise a detection layer. The detection layer is configured to detect the presence and the position of an element in the input data tensor. For example, the detection layer can be configured to detect an object or a person in an image used as an input data tensor. The detection layer is configured to generate a value matrix which can be interpreted by the application. The matrix can for example correspond to a position and to dimensions of a detection frame delimiting a detected element, as well as to a probability associated with this detection element.

FIG. 4 illustrates a microcontroller MCU comprising a processing circuitry UT (which may be referred to herein as processing unit UT) and a non-transitory computer-readable memory MEM in which a computer program PRG is stored. The computer program PRG includes instructions which, when the program PRG is executed by the processing unit UT, lead it to implement a neural network NN, such as those described in relation to FIGS. 1 to 3.

FIG. 5 illustrates a method for processing a data tensor. The method includes a step 50 of obtaining the data tensor. For example, a microcontroller MCU such as that described in FIG. 4 can be configured to be able to obtain a data tensor generated by a sensor. The method then comprises a step 51 of implementing a neural network, such as those described in relation to FIGS. 1 to 4. The neural network NN is then implemented by receiving as input the data tensor. The neural network can be implemented by the microcontroller processing unit of FIG. 4.

What is claimed is:

1. An artificial neural network, comprising:
at least one unit cell, the at least one unit cell including:
a first binary two-dimensional convolution layer configured to receive an input tensor and to generate a first tensor;
a first batch normalization layer configured to receive the first tensor and to generate a second tensor;
a concatenation layer configured to generate a third tensor by concatenating the input tensor and the second tensor;
a second binary two-dimensional convolution layer configured to receive the third tensor and to generate a fourth tensor; and
a second batch normalization layer configured to generate an output tensor based on the fourth tensor.

2. The artificial neural network according to claim 1, wherein the first binary two-dimensional convolution layer is configured to perform a depthwise convolution on the input tensor.

3. The artificial neural network according to claim 1, wherein the second binary two-dimensional convolution layer is configured to perform a pointwise convolution on the third tensor generated by the concatenation layer.

4. The artificial neural network according to claim 1, wherein the at least one unit cell includes a pooling layer between the second binary two-dimensional convolution layer and the second batch normalization layer.

5. The artificial neural network according to claim 1, further comprising at least one attribute extraction layer configured to extract attributes from an input data tensor and to generate the input tensor based on the extracted attributes, the at least one unit cell being configured to receive as input the input tensor based on the extracted attributes.

6. The artificial neural network according to claim 1, further comprising at least one classification layer configured to:
receive the output tensor generated at an output of the at least one unit cell;
classify a data tensor received at an input of the neural network based on the output tensor generated at the output of the at least one unit cell; and
output a signal indicative of the classification of the data tensor.

7. The artificial neural network according to claim 1, further comprising at least one detection layer configured to:
receive the output tensor generated at an output of the at least one unit cell;
detect elements in a data tensor received at an input of the neural network based on the output tensor generated at the output of the at least one unit cell; and
output a signal indicative of the detected elements.

8. The artificial neural network according to claim 1, wherein the at least one unit cell includes a plurality of successive unit cells.

9. A computer program product, comprising instructions which, when executed by processing circuitry, cause the processing circuitry to implement an artificial neural network, the artificial neural network comprising:
at least one unit cell, the at least one unit cell including:
a first binary two-dimensional convolution layer configured to a first tensor based on an input tensor;
a first batch normalization layer configured to generate a second tensor based on the first tensor;
a concatenation layer configured to generate a third tensor based on the input tensor and the second tensor;
a second binary two-dimensional convolution layer configured to generate a fourth tensor based on the third tensor; and
a second batch normalization layer configured to generate an output tensor based on the fourth tensor.

10. A device comprising:
a computer-readable memory configured to store instructions for implementing an artificial neural network; and
processing circuitry configured to implement the artificial neural network by executing the instructions stored in the computer-readable memory, the artificial neural network comprising:
at least one unit cell, the at least one unit cell including:
a first binary two-dimensional convolution layer configured to receive an input tensor and to generate a first tensor;
a first batch normalization layer configured to receive the first tensor and to generate a second tensor;
a concatenation layer configured to generate a third tensor by concatenating the input tensor and the second tensor;
a second binary two-dimensional convolution layer configured to receive the third tensor and to generate a fourth tensor; and
a second batch normalization layer configured to generate an output tensor based on the fourth tensor.

11. The device according to claim 10, wherein the first binary two-dimensional convolution layer is configured to perform a depthwise convolution on the input tensor.

12. The device according to claim 10, wherein the second binary two-dimensional convolution layer is configured to perform a pointwise convolution on the third tensor generated by the concatenation layer.

13. The device according to claim 10, wherein the at least one unit cell includes a pooling layer between the second binary two-dimensional convolution layer and the second batch normalization layer.

14. The device according to claim 10, wherein the artificial neural network further includes at least one attribute extraction layer configured to extract attributes from an input data tensor and to generate the input tensor based on the extracted attributes, the at least one unit cell being configured to receive as input the input tensor based on the extracted attributes.

15. The device according to claim 10, wherein the artificial neural network further includes at least one classification layer configured to:
receive the output tensor generated at an output of the at least one unit cell;
classify a data tensor received at an input of the neural network based on the output tensor generated at the output of the at least one unit cell; and
output a signal indicative of the classification of the data tensor.

16. The device according to claim 10, wherein the artificial neural network further includes at least one detection layer configured to:
receive the output tensor generated at an output of the at least one unit cell;
detect elements in a data tensor received at an input of the neural network based on the output tensor generated at the output of the at least one unit cell; and
output a signal indicative of the detected elements.

17. The device according to claim 10, wherein the at least one unit cell includes a plurality of successive unit cells.

18. A method, comprising:
generating, by a first binary two-dimensional convolution layer of a unit cell of an artificial neural network, a first tensor based on an input tensor;
generating, by a first batch normalization layer of the unit cell, a second tensor based on the first tensor;
generating, by a concatenation layer of the unit cell, a third tensor by concatenating the input tensor and the second tensor;
generating, by a second binary two-dimensional convolution layer of the unit cell, a fourth tensor based on the third tensor; and
generating, by a second batch normalization layer of the unit cell, an output tensor based on the fourth tensor.

19. The method according to claim 18, wherein generating the first tensor includes performing, by the first binary two-dimensional convolution layer, a depthwise convolution on the input tensor.

20. The method according to claim 18, wherein generating the fourth tensor includes performing, by the second binary two-dimensional convolution layer, a pointwise convolution on the third tensor.
